(19) United States
(12) Patent Application Publication
(10) Pub. No.: US 2021/0246359 A1
(43) Pub. Date: Aug. 12, 2021

(54) PROCESS FOR REMOVAL OF CONTAMINANTS FROM OFFSHORE OIL AND GAS PIPELINES

(71) Applicant: CHEVRON U.S.A. INC., San Ramon, CA (US)

(72) Inventors: Thomas HOELEN, Berkeley, CA (US); Adam DASSEY, Houston, TX (US); Russell COOPER, Martinez, CA (US)

(21) Appl. No.: 17/172,140

(22) Filed: Feb. 10, 2021

Related U.S. Application Data
(60) Provisional application No. 62/972,625, filed on Feb. 10, 2020.

(51) Int. Cl. C09K 8/528

(52) U.S. Cl. CPC C09K 8/528

(57) ABSTRACT

A process for offshore decontamination of subsurface pipelines comprising

1) removal of a metal of potential concern from the internal pipeline surface, 2) evacuation of the separated MOPCs from the pipeline, 3) offshore treatment and disposal of generated waste materials, and 4) verification that MOPCs are reduced to below a desired target limit.

### TECHNICAL FIELD

The invention relates generally to a process, method, system, and management plan for removal and control of unwanted materials including but not limited to as mercury and arsenic accumulating on subsea pipes.

### BACKGROUND

Heavy metals such as mercury can be present in trace amounts in all types of produced fluids such as hydrocarbon gases, crude oils, and produced water. The amount can range from below the analytical detection limit to several thousand ppbw (parts per billion by weight) depending on the source. Mercury has been predominately managed with mercury removal adsorbent beds in facilities handling hydrocarbon gases and liquids, and by operationally managing mercury with mercury specific personal protection equipment (“PPE”) and procedures.

Crude oil and gas in reservoirs can contain trace levels of inorganic compounds, including nickel, vanadium, mercury, arsenic, manganese, tungsten, and selenium, as well as Naturally Occurring Radioactive Matter (NORM), which can potentially have a negative impact to the environment when released in one form or another to the atmosphere or marine water bodies. These compounds are defined here as Materials of Potential Concern (MOPCs). During production and transport of produced reservoir fluids, some MOPCs may deposit on the inside walls of steel pipelines, often in association with corrosion and scale deposits. MOPCs may be present in their elemental forms, as salts, or as an organometallic form. After removing a subsea pipeline from service, it is sometimes desired to abandon the pipeline in place and allow natural weathering processes to degrade the pipeline. If MOPCs are present on the inside surface of a subsea pipeline, it may be desired to remove a portion or all the MOPCs prior to in-place abandonment of a pipeline.

When MOPCs are strongly bound to the inner surface of a pipeline, typical offshore pipeline cleaning strategies such as progressive pigging and seawater flushing are not sufficient to remove significant amounts of MOPCs from the pipelines. Several methodologies have been proposed and are currently deployed to remove scale and corrosion layers from internal surfaces of pipelines. For example, O'Rear et al. (2018) has disclosed an in-situ pipeline decontamination technology based on thermal treatment, but the feasibility of this approach has not been demonstrated and no associated technology has been developed. An alternative technology based on treatment with caustic sulfide solution has been proposed by O'Rear et al., U.S. Pat. No. 9,902,909; however, the application of this approach may be limited because of potential practical restrictions on the use of caustic sulfides in offshore environments, the potential for generation of toxic levels of H₂S, and dissolution of MOPC containing minerals. The latter often increases bioavailability and chemical reactivity of MOPCs, which should be avoided. Also, associated issues with the presence of MOPCs, such as effective evacuation of particulate MOPCs from the pipelines to prevent leaving significant quantities behind, and offshore treatment and disposal of spent chemicals, have not been documented. Therefore, there is a need for a practical, effective, and safe process for in-situ removal of MOPCs from offshore subsea pipelines and safe disposition of waste streams generated during the cleaning process.

Currently the surface concentrations of MOPCs on the inside of subsea pipelines can only be evaluated through destructive sampling, e.g., removing an entire pipeline, cutting multiple pieces of pipeline, or drilling cores from the subsea pipeline. In each case, removal has to occur at the seafloor and the piece of metal must be brought to the surface for analysis. These methods are complicated, time consuming, expensive, and can be dangerous because of the need to use subsea divers to manually cut the pipeline. It can be particularly challenging to obtain a good understanding of average MOPCs concentrations when the distribution of MOPCs on the inside pipeline surface is highly heterogeneous. Several methods for in-situ sampling have been proposed, including the use of an in-situ XRF-based device (Gallup and Spurell, 2010) or an in-situ solid sample collector (Chanvanichskul et al., 2017). However, these methods have not been demonstrated to be effective in the field, are likely complicated and costly to deploy, and may not be able to practically obtain sufficient readings to obtain a detailed understanding of average MOPC concentrations over the length of a pipeline.

### SUMMARY OF INVENTION

A process to remove materials of potential concern, alternatively described herein as MOPCs, from subsea pipelines comprising: 1) removal of the MOPCs from the internal pipeline surface, without generation of significant amounts of H₂S, 2) evacuation of the separated MOPCs from the pipeline, 3) offshore treatment and disposal of generated waste materials, and 4) verification that MOPCs are reduced to below a desired target limit.

### BRIEF DESCRIPTION OF THE DRAWINGS

FIG. 1 is a table of removal of MOPCs from metal surfaces.

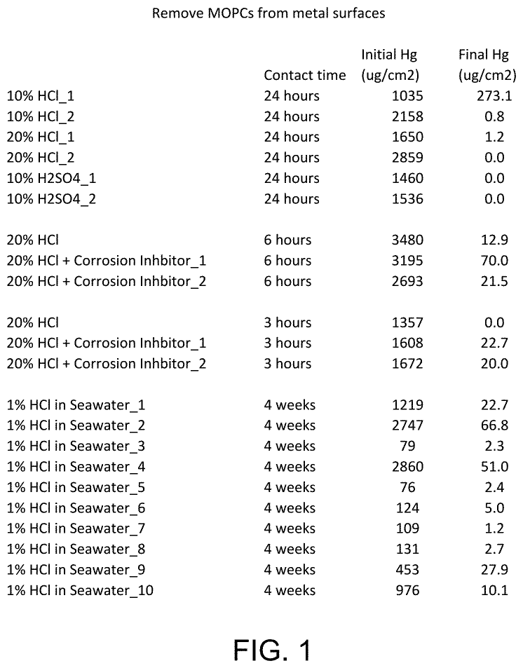

FIG. 2 is a plot of evacuation of MOPCs from a pipeline.

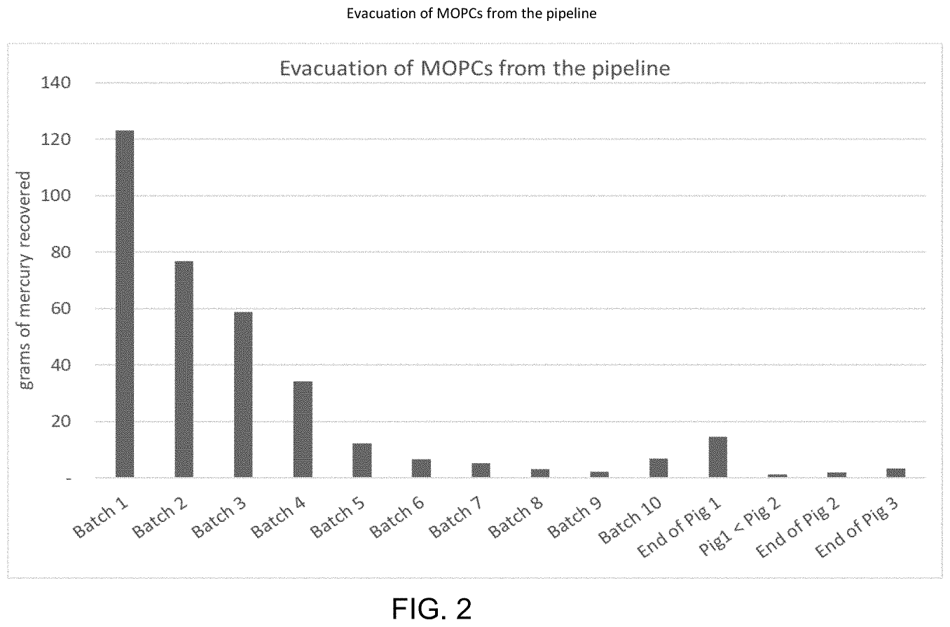

FIG. 3 is a graph of mercury concentration(s) after neutralization.

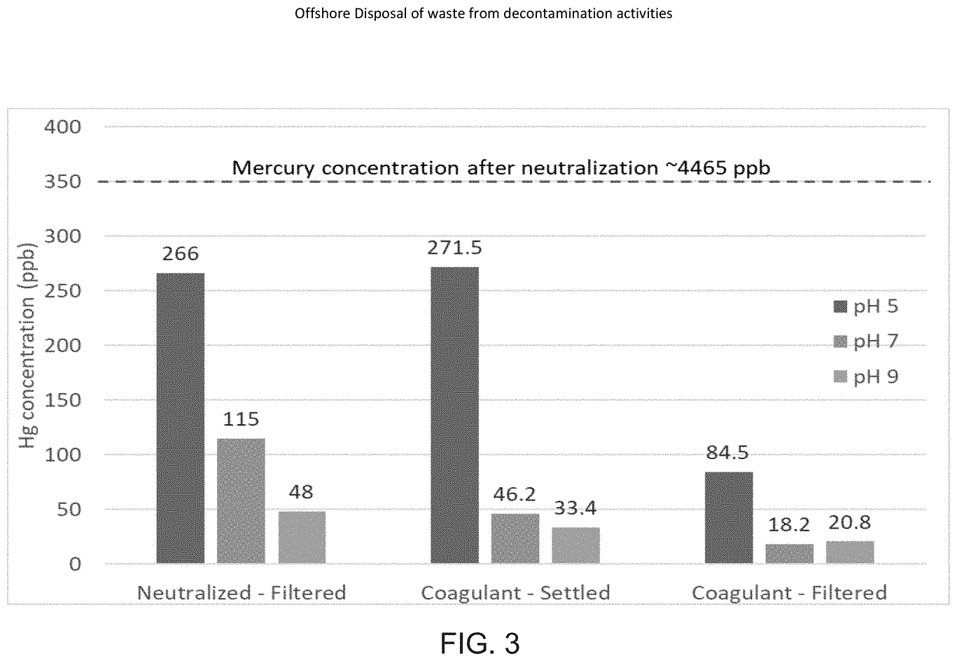

FIG. 4 is a graph and associated table of the mass of mercury detected in the chemical flushing and mass of mercury removed from pipe.

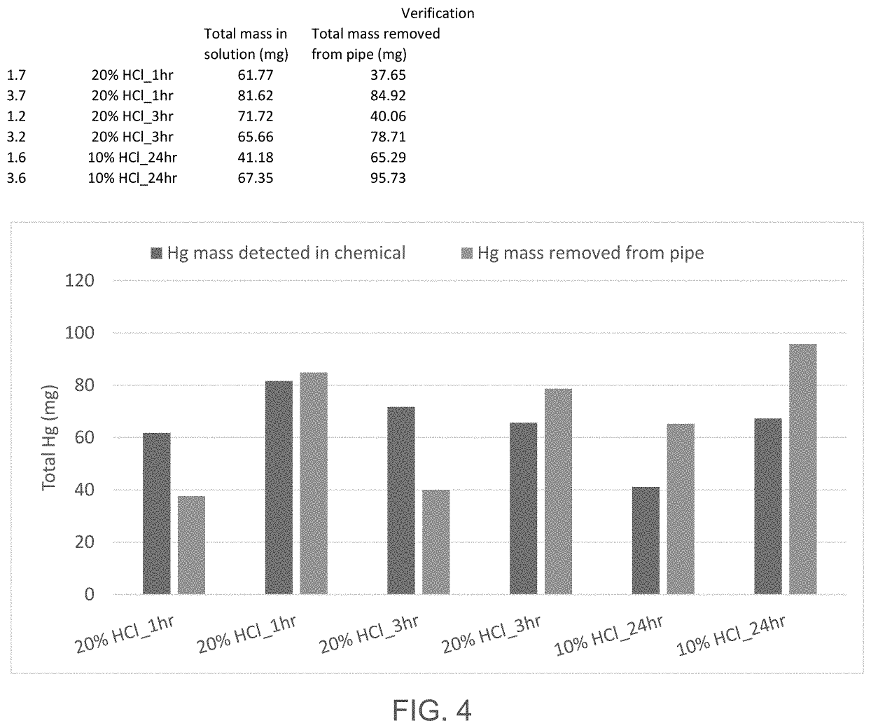

### DETAILED DESCRIPTION

The following terms will be used throughout the specification and will have the following meanings unless otherwise indicated.

“Flowline” refers to a pipe that transfers fluid from an oil or gas well to a processing facility. It might also transfer fluid from a smaller facility to a larger one within a given oil field.

“Pipeline” refers to a pipe that transfers gas, crude oil, produced water, gasoline or other finished product from a processing facility or storage facility to another location be it another processing facility, refinery, chemical plant or end user. As used herein, a pipe or pipeline refers to both flowline and pipeline, and pipeline is used interchangeably with flowline.

“Subsea” as used herein refers to an assembly of production equipment placed in a marine body. The marine body may be an ocean environment or a freshwater lake. Similarly, “subsea” includes both an ocean body and a deep-water lake.

“Trace amount” refers to the amount of mercury in the produced fluids. The amount varies depending on the source, e.g., ranging from a few μg/Nm³ to up to 30,000 μg/Nm³ in natural gas, from a few ppbw to up to 30,000 ppb in crude oil.

“Mercury salt” or “mercury complex” means a chemical compound formed by replacing all or part of hydrogen ions of an acid with one or more mercury ions.

“Mercury sulfide” may be used interchangeably with HgS, referring to mercurous sulfide, mercuric sulfide, and mixtures thereof. Normally, mercury sulfide is present as mercuric sulfide with an approximate stoichiometric equivalent of one mole of sulfide ion per mole of mercury ion. Mercury sulfide can be present in crystalline phases include cinnabar, metacinnabar and hypercinnabar with metacinnabar being the most common.

In one embodiment for the transport of a produced fluid having a first concentration of mercury in a pipeline, after a sufficient amount of time for mercury to be adsorbed/deposited on the pipeline, the mercury content at certain intervals along the pipeline and/or an exit point downstream is monitored. Once the concentration of mercury at the checkpoint reaches a certain level, e.g., at least 50% of the first concentration, a cleaning of the pipeline by chemical or thermal methods can be initiated. In another embodiment, the cleaning can be initiated after a certain interval of time, e.g., according to maintenance schedule of every few months, every year, etc.

Herein is described a process to remove MOPCs from subsea pipelines that addresses four issues: 1) remove the MOPCs from the internal pipeline surface without a generation of significant amounts of H₂S, 2) evacuate the separated MOPCs from the pipeline, 3) offshore treatment and disposal of generated waste materials, and 4) verification that MOPCs are reduced to below a desired target limit. Here, we disclose a novel process for offshore decontamination of subsurface pipelines that addresses these issues and can be performed cost-effectively and safely.

1. Removal of MOPCs from internal pipeline surfaces. The pipeline is filled with a dilute mineral acid solution including but not limited to hydrochloric acid, sulfuric acid, or a mixture thereof, that may mobilize MOPC species and/or dissolve or embrittle minerals that bind MOPCs to the pipeline surfaces. Relevant minerals that may bind MOPCs include but are not limited to iron carbonates, calcium or magnesium carbonates, iron oxides, iron hydroxides, or iron sulfides. Dilute acids can be transported to a desired offshore location in chemically resistant tanks, for example in ECB tanks or barges, and further diluted offshore before or during introduction into a pipeline. The acid solution is left in the pipeline to allow reaction with the inside surface of the pipeline. Depending on site specific conditions such as removal target, acid strength, and composition of the internal pipeline surface, the contact time may vary from several minutes to several months or more. After desired contact time, the diluted acid is removed from the pipeline, for example by chemically resistant polyurethane sealing pigs propelled by pressurized seawater or compressed gas, and collected in storage tanks. Storage tanks, pumps, hoses, and other equipment can be present on offshore platforms or on vessels such as barges or Floating (Production) and Storage and Offloading (F(P)SO) vessels.

In one embodiment, the acid used is selected from diluted HCl, H2SO4, HNO3, HF, (NH4)HF2, organic acids such as acetic acid, oxalic acids, and mixtures thereof.

In one embodiment, the acid is diluted with aerated seawater, which can enhance degradation rates of MOPCs compounds or materials that bind MOPCs to the pipeline surface. The chlorine and sulfate ions present in seawater can form aqueous complexes with dissolved forms of MOPCs, preventing dissolved MOPCs from precipitation or sorption to pipeline surfaces and solids, thereby enhancing the effectiveness of removal of MOPCs.

In one embodiment, specialized pigs are used after treatment with diluted acid to remove remaining solids from the pipeline surface comprising using aggressive pigs or known to one of skill in the art as aggressive pigging, thereby removing more MOPCs from the pipeline surface.

In one embodiment, at least a chemical treatment step is used in conjunction with a progressive pigging technique, with the use of a plurality of pigs or “pig train” to help contain the liquid in a column form within the pipeline, with each pig being used to create a “pig slug” mass. As used herein the term “pig” is to be given its broadest possible meaning and includes all devices that are known as or referred to in the pipeline arts as a “pig,” a device that is inserted into and moved along at least a portion of the length of a pipeline to perform activities such as inspecting, cleaning, measuring, analyzing, maintaining, welding, assembling, or other activities known to the pipeline arts. The pig can be driven through the pipeline with hydraulic pressure, or it can be propelled by the pressure of a fluid, including but not limited to the produced fluid or gas flowing in the pipeline, the aqueous acidic solution, compressed air, seawater, or a flushing solution. The pig can also be pulled along by a cable, such as a cable which was laid down by a previous pig that moved by hydraulic pressure.

The pigs can be unitary devices, as simple as a foam or metal ball, or a complex multi-component device such as a magnetic flux leakage pig. In another embodiment, pigs are devices that travel along its length and are moved through the pipeline by the flow of the material within the pipe. In yet another embodiment, the pigs used can be for both utility and in-line/intelligent functions. Utility pigs for example are used for utility functions such as cleaning. Intelligent pigs may also perform functions such as instrumentation, supplying/conveying information on the condition of the pipeline, including but not limited to thickness, location, extent of problems with the pipeline.

The pig can be constructed of any resilient material which is resistant to swelling upon contact with produced fluids or moisture. Generally the shape of the pig conforms to the cross section or configuration of the flowline to be cleaned for either spherical or cylindrical. The pig can be configured for its size to be adjustable/adaptable to the pipeline opening. Different types of pigs can be used in a progressive pigging technique, e.g., pigs having a solid form for plugging the pipeline forming a column, pigs with wire brush for initial cleaning/removal of wax from the pipelines, pigs with spring loaded blades, etc.

In one embodiment, a volume of diluted mineral acid that is smaller than the total pipeline volume is moved through the pipeline as an acid slug to reduce the total amount of acid that is required for treatment of the entire pipeline. The acid slug can be separated from pipeline fluids by chemically resistant sealing pigs. The acid slug may be propelled with fresh water, seawater, air, or an inert gas. If desired, movement of the slug can be temporarily stopped at multiple locations in the pipeline to increase the contact time. The used acid can be collected at the receiving end and reused for treatment in a follow-up acid slug. On-site measurement of pH or acid strength, iron, and/or MOPCs in used acid can indicate if the acid is considered spent as in lacking sufficient acid strength to be effective for additional treatment or if the MOPCs on the pipeline surfaces are being depleted. If desired, multiple treatments with mineral acids can be alternated by physical removal such as aggressive pigging, to remove solids and reduce the total volume of acid needed for treatment.

In one embodiment, the acid solution is amended with an acid resistant corrosion inhibitor to limit reaction of acid with uncorroded base metal.

In one embodiment, the acid solution is amended with an acid resistant sulfide scavenger, for example glyoxal, to prevent the accumulation of hydrogen sulfide gas during contact of acids with the internal pipeline surface when pipeline deposits contain sulfide minerals.

2. Evacuation of MOPCs from the pipeline. Some MOPCs will be dissolved or dispersed as fine solids in the acid solution and will therefore be removed with the acid solution. Specific oilfield pigs can be used to remove a portion of solids from subsea pipelines. However, a fraction of the MOPCs may be associated with solids that remain behind in the pipeline and are not removed by liquids, gases, or pigs. These solids can be effectively removed by propelling one or more gel plugs, i.e., fresh or seawater that has been turned into a gel to increase the viscosity, through the acid treated pipeline.

In one embodiment, spent gels with MOPC containing solids removed are collected at the receiving end of the pipeline, and mixed with spent acids from the decontamination activities. The low pH will cause the gels to break and release the MOPCs. This process can also partially neutralize the pH of the spent acids.

3. Offshore disposition of waste from decontamination activities. Spent acids may be disposed by subsea injection wells, for example produced water injection wells or slurry injection wells. However, certain restrictions on waste composition must be met, which may include pH, total suspended solids (TSS), total dissolved solids (TDS), and concentrations of individual MOPCs. The following steps may be required or desired to adjust pH, TSS, TDS, and MOPC concentrations.

A) Neutralization. The pH of the spent acid can be neutralized to a desired pH (e.g., between pH 5 and pH 9) by mixing with a caustic solid in a reaction vessel, such as soda ash (NaOH), sodium carbonate (Na2CO3), or sodium bicarbonate (NaHCO3), or by mixing with a caustic aqueous solution of caustic solids. Depending on the initial pH, the vessel may need to be closed, may need to be cooled, and/or caustics need to be added slowly to prevent excessive heating of the waste and release of potentially toxic vapors. Oxidizing agents such as air, hydrogen peroxide, or sodium hypochlorite can be added prior to, during, or after neutralization to control the redox potential of treated spent acids.

B) Reductions in TDS and TSS. The neutralization may cause dissolved compounds to precipitate, in particular iron, which is highly soluble at low pH but poorly soluble at circumneutral pH. This will strongly reduce the TDS. Precipitated solids can be removed from the neutralized solution, e.g., by gravity separation such as settling, filtration, or centrifugation. If needed, TSS can be further reduced by introduction of a coagulant such as ferric iron chloride (FeCl3) and flocculants followed by flotation, filtration, or centrifugation.

C) Reductions in specific MOPCs. Many dissolved MOPCs co-precipitate when ferric iron precipitates. Spent acids will contain elevated concentrations of dissolved iron after being in contact with steel and steel corrosion products. Neutralization will cause a substantial amount of this dissolved iron to precipitate, which can result in co-precipitation of dissolved MOPCs, e.g., dissolved arsenic and mercury will be strongly reduced as a result of neutralization. If desired, removal through co-precipitation can be enhanced by the addition of a coagulant such as ferrous chloride, followed by neutralization. Further removal of specific MOPCs can be accomplished by the addition of a flocculant that has been designed to remove dissolved metals from solutions, and/or an adequate sorbent such as activated carbon. Depending on site specific conditions and requirements, water and solids can be slurried and injected into a water injection well or waste disposal well, separated water can be injected or discharged overboard, and solids containing the majority of MOPCs can be dewatered, solidified and stabilized if needed, and sent to an adequate waste management facility for disposal, additional treatment and disposal, or treatment and (partial) re-use.

4. Verification. Exposure of an inner surface of a decommissioned subsea pipeline from the oil industry to a diluted mineral acid, e.g., hydrochloric acid or sulfuric acid, will release a portion of minerals embedded into the pipeline surface to be released to the acid, in either dissolved or particulate form. The average surface concentration of a pipeline can therefore be estimated by chemical analysis of a slug of acid that has been moved through a pipeline, for example in between two chemically resistant sealing pigs that are propelled by compressed water, seawater, air, or an inert gas. This analysis can be performed offshore or onshore with a portable analyzer, for example with an atomic adsorption spectrometer, or in an analytical laboratory. The acid sample may need to be diluted, treated with a caustic solid or liquid to increase the pH, treated with an oxidizer to dissolve solids and solubilize MOPCs from solids, and/or filtered to remove solids. If samples are filtered, MOPC concentrations may need to be analyzed in both filtrate and filter residue. Depending on site specific conditions such as starting concentration and volume of the mineral acid, pipeline length, pipeline diameter, average pigging speed, and composition of the inner surface of the pipeline, average MOPC concentrations in the subsurface pipeline can be evaluated. The acid concentrations should be of sufficient strength (e.g., 5%-50% solutions) to allow sufficient release of MOPCs to the acid and prevent substantial reductions in acid strength due to reactions in the pipeline.

In one embodiment, fresh acids are diluted offshore to their desired strengths with seawater.

In another embodiment, a larger volume of an acid with a reduced strength (e.g., 0.1%-5%) is used to evaluate the surface concentration.

In a further embodiment, the entire pipeline is filled with a dilute mineral acid solution, allowed to contact for a defined time period, and removed for chemical analysis of MOPCs.

What is claimed:

1. A process to remove materials of potential concern from subsea pipelines comprising: 1) removal of the materials metals of potential concern from the internal pipeline surface by filling the pipeline with dilute mineral acids, 2) evacuation of the separated metals of potential concern from the pipeline, 3) offshore treatment and disposal of generated waste materials, and 4) verification that the metals of potential concern are reduced to below a safe target limit.

2. The process of claim 1, wherein the mineral acid is selected from the group consisting of HCl, H2SO4, HNO3, HF, (NH4)HF2, organic acids such as acetic acid, oxalic acids, and mixtures thereof.

3. The process of claim 2, wherein a pig is used after the mineral acid addition to remove remaining solids from the pipeline surface.

4. The process of claim 1, wherein the evacuation of the separated metals of potential concern is achieved by use of a gel plug.

5. The process of claim 1, wherein the offshore treatment consists of neutralization of the acids.

4. The process of claim 5, wherein the verification is achieved using an atomic adsorption spectrometer.
